(19) United States
(12) Patent Application Publication
(10) Pub. No.: US 2006/0221376 A1
(43) Pub. Date: Oct. 5, 2006

(54) Print control apparatus and method

(75) Inventor: Hisashi Matsumoto, Yokohama-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/390,825

(22) Filed: Mar. 28, 2006

(30) Foreign Application Priority Data
Mar. 31, 2005 (JP) 2005-103819

(51) Int. Cl. G06K 15/00

(52) U.S. Cl. 358/1.14; 358/1.15

(57) ABSTRACT

A print control apparatus is provided which inhibits an output of content data if a destination of the content data is a virtual printer for converting the content data to a file.

### BACKGROUND OF THE INVENTION

1. Field of the Invention

The present invention relates to a print control apparatus and method.

2. Description of the Related Art

Presently there are services provided by content providers distributing content to users on a chargeable basis over the Internet. In many cases, the content has its own copyright or right of portrait like a photograph of an artist or actor/actress, local information, a coupon ticket, a novel and so forth, or the content itself is a marketable security. Moreover, it is conceivable that we could enter an age of electronic government in the future, and thereby, important documents issued by government and other public offices may be printed by home personal computers.

Conventionally, when distributing content over the Internet, the content is in danger of being illegally copied or stolen by a malicious user, which causes a serious problem of the protection of the intellectual property with regard to the content. Moreover, it is easy to make a plural number of copies with a setting of the number of copies on a printer driver when printing on a home printer.

To protect content to be distributed, conventionally a communication path has been encrypted to prevent data from being stolen or content data has been encrypted to protect the content data downloaded from the Internet.

The above content protection system is very effective to protect content up to the point of downloading data. No measure, however, is taken against printing after the downloading. In most homes, people use their own printers for printing via a printer driver. The printer driver includes the setting of “leaving the document after printing,” by which data (raw data) sent to the printer can be stored and therefore a plural number of copies can be made by using the data. Moreover, it is also possible to create bitmap data or a PDF or other files from the content data by using a virtual printer, instead of outputting the data to the printer.

### SUMMARY OF THE INVENTION

An aspect of the present invention is to prevent content from being illegally copied by a malicious user. Another aspect of the present invention is to inhibit an output of content data if a destination of the content data is a virtual printer for converting the content data to a file. Still another aspect of the present invention is to inhibit an output of content data if parameters of a printer driver for a destination of the content data include a predetermined keyword.

According to one embodiment of the present invention, a print control apparatus is provided which includes a request unit configured to request an output of content data; and an inhibiting unit configured to inhibit the output of the content data if a destination of the content data is a virtual printer for converting the content data to a file. According to another aspect of the embodiment, the inhibiting unit resets a mode that allows spooled data to be stored so that the spooled data cannot be stored, unless the destination of the content data is a virtual printer for converting the content data to a file. And according to another aspect of the embodiment, the apparatus further includes a downloading unit for downloading the content data from a server.

According to another embodiment of the present invention, a print control method is provided which includes detecting a request for an output of content data; and inhibiting the output of the content data if a destination of the content data is a virtual printer for converting the content data to a file. According to another aspect of the embodiment, the inhibiting includes resetting the mode that allows spooled data to be stored so that the spooled data cannot be stored, unless the destination of the content data is a virtual printer for converting the content data to a file.

According to still another embodiment of the present invention, a print control program is provided which includes code configured to detect a request for an output of content data; and code configured to inhibit the output of the content data if a destination of the content data is a virtual printer for converting the content data to a file. According to another aspect of the embodiment, the code configured for includes code configured to reset the mode that allows spooled data to be stored so that the spooled data cannot be stored, unless the destination of the content data is a virtual printer for converting the content data to a file.

According to yet another embodiment of the present invention, a print control apparatus is provided which includes a request unit configured to request an output of content data; and an inhibiting unit configured to inhibit the output of the content data if parameters of a printer driver for a destination of the content data include a predetermined keyword. According to another aspect of the embodiment, the inhibiting unit resets the mode that allows spooled data to be stored so that the spooled data cannot be stored, unless the parameters include the predetermined keyword.

According to still yet another embodiment of the present invention, a print control method is provided which includes detecting a request for an output of content data; and inhibiting the output of the content data if parameters of a printer driver for a destination of the content data include a predetermined keyword. In another aspect of the embodiment, the inhibiting includes resetting the mode that allows spooled data to be stored so that the spooled data cannot be stored, unless the parameters include the predetermined keyword.

According to another embodiment of the present invention, a print control program is provided which includes code which performs the steps of detecting a request for an output of content data; and inhibiting the output of the content data if parameters of a printer driver for a destination of the content data include a predetermined keyword. According to another aspect of the embodiment, the inhibiting step includes resetting the mode that allows spooled data to be stored so that the spooled data cannot be stored, unless the parameters include the predetermined keyword.

Other embodiments, features and aspects of the present invention will become apparent from the following description.

### BRIEF DESCRIPTION OF THE DRAWINGS

FIG. 1 is a diagram schematically showing an exemplary distribution and printing system including a content distribution apparatus according to an embodiment of the present invention.

FIG. 2 is a diagram schematically showing an exemplary internal architecture of a personal computer shown in FIG. 1.

FIG. 3 is a flowchart showing an exemplary procedure for a preparatory process for distribution, which is executed by the content distribution server shown in FIG. 1.

FIG. 4 is a flowchart showing an exemplary procedure for a preparatory process for printing, which is executed by the personal computer shown in FIG. 1.

FIG. 5 is a flowchart showing an exemplary procedure for a printing process executed by the printer shown in FIG. 1.

FIG. 6 is a flowchart showing an exemplary procedure for a printer driver check process executed in step S502 shown in FIG. 5.

FIG. 7 is a flowchart showing an exemplary procedure for a printer driver setting process executed in step S504 shown in FIG. 5.

FIG. 8 is a flowchart showing an exemplary procedure for an alteration of the printer driver check process shown in FIG. 6.

### DESCRIPTION OF THE EMBODIMENTS

Numerous embodiments, features and aspects of the present invention will now herein be described in detail in accordance with the accompanying drawings.

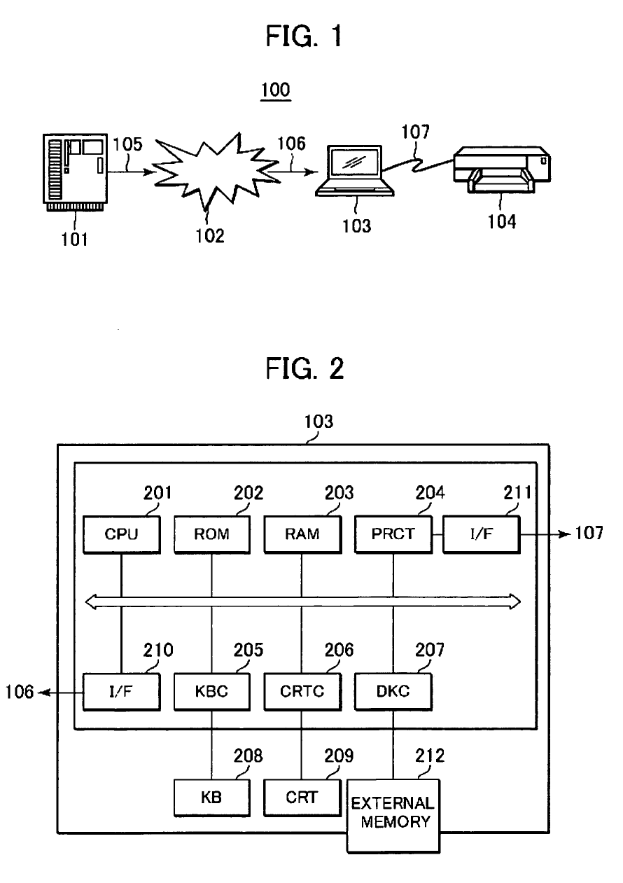

FIG. 1 schematically shows an exemplary content distribution and printing system 100 including a content distribution apparatus 101 according to an embodiment of the present invention.

The content distribution and printing system 100 includes a content distribution server 101 for distributing content and a personal computer (PC) 103 connected to the server 101 via the Internet 102. The content distribution and printing system 100 further includes a printer 104 for printing content with the control of the PC 103, the printer 104 being connected to the PC 103 via an interface cable 107 such as a USB cable. The server 101 is connected to the Internet 102 via a communication path 105, and the Internet 102 is connected to the PC 103 via a communication path 106. Although not shown here, generally there is a storage device or the like storing content data separately, in addition to the above.

FIG. 2 schematically shows an exemplary internal architecture of the PC 103 shown in FIG. 1. The content distribution server 101 also has a similar internal configuration as shown in FIG. 2.

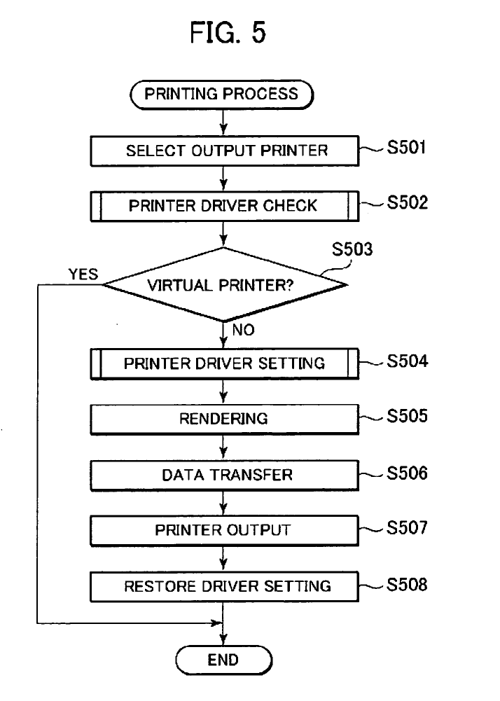

Referring to FIG. 2, the PC 103 includes a CPU 201 for performing processing (such as the processes shown in FIG. 4 and FIG. 5 described later), a ROM 202 for storing a control program, and a RAM 203 functioning as a main memory, a work area, and so forth for the CPU 201. The PC 103 further includes a printer controller (PRCT) 204 for executing communication control processing with the printer 104, a keyboard controller (KBC) 205, a CRT controller (CRTC) 206, and a disk controller (DKC) 207. Moreover, the PC 103 further includes a system bus 200 connecting them to each other. The system bus 200 is connected to the content distribution server 101 via an interface (I/F) 210 and the Internet 102, and the PRCT 204 is connected to the printer 104 via an interface (I/F) 211 and the interface cable 107.

The PC 103 further includes a keyboard (KB) 208 connected to the KBC 205, a CRT 209 connected to the CRTC 206, and an external memory 212 such as an HDD, an FDD, an IC card, and so forth connected to the DKC 207.

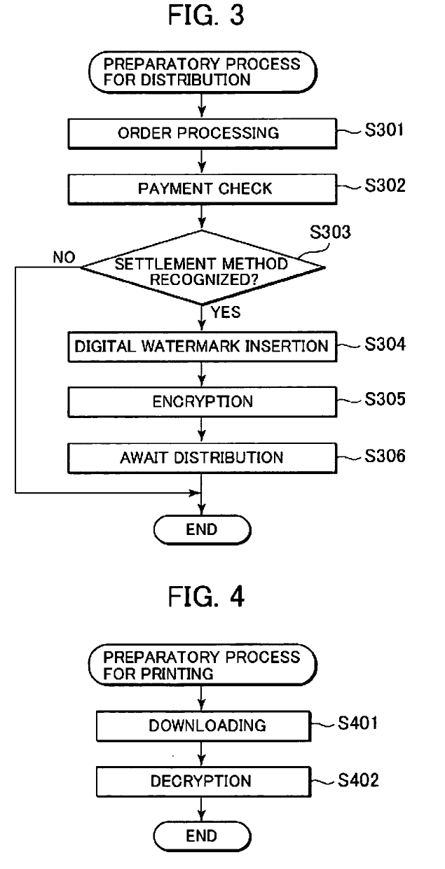

FIG. 3 shows an exemplary flowchart illustrating the procedure for a preparatory process for distribution executed by the content distribution apparatus shown in FIG. 1.

Referring to FIG. 3, a customer performs order processing on the Web (step S301), the customer checks the payment (step S302), and then the distribution server 101 performs the processes described below upon recognition of the settlement method such as a credit card payment or a cash transfer (YES in step S303). More specifically, the distribution server 101 performs a process of inserting a digital watermark into content data (step S304) and a process of encrypting the content data (step S305). The distribution server 101 further awaits the distribution of the content data, which has been already processed in the above, on the distribution server 101 (step S306) and then terminates this process. The content in the wait state for distribution is distributed to the PC 103 via the communication path encrypted by SSL or the like over the Internet 102. On the other hand, in step S303, if a settlement method is not recognized (NO in step S303), the process ends.

FIG. 4 shows a flowchart illustrating an exemplary procedure for a preparatory process for printing executed by the PC 103 shown in FIG. 1.

Referring to FIG. 4, the PC 103 downloads the content distributed by the distribution server 101 (step S401), decrypts the encrypted content data to obtain plain data (step S402), and then terminates this process. It is noted here that the PC 103 may download and decrypt the content into the memory inside the PC 103 in this process, instead of downloading and decrypting it in the form of a file.

FIG. 5 shows a flowchart illustrating an procedure for a printing process executed by the printer 104 shown in FIG. 1. In this process, it is assumed as a precondition that the printer driver of the printer 104 for use in printing is installed in the PC 103.

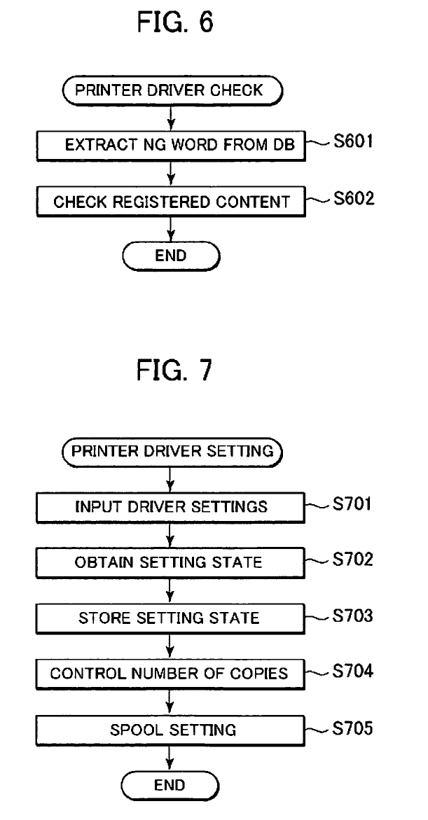

Referring to FIG. 5, a printer for outputting the content is selected (step S501), a printer driver check process shown in FIG. 6 is performed (step S502), and it is determined whether the output printer is a virtual printer on the basis of a result of the printer driver check process (step S503). If the output printer is a virtual printer, this process is immediately terminated. On the contrary, unless the output printer is a virtual printer, a printer driver setting process for the output printer (FIG. 7) is performed (step S504). At the time of the printer driver setting, setting is made through an internal processing in such a way as to inhibit an illegal output. The details thereof will be described later.

Subsequently, the content data is rendered (step S505) and then delivered to the printer driver, where it is converted to data (raw data) that can be read by the printer 104. The data is then transferred via the interface cable 107 (step S506). Upon receiving the data, the printer 104 outputs the data (step S507). After the output from the printer 104, the driver setting, which has been changed in step S504, is restored to its original state (step S508) and then this process is terminated. After the end of printing, the PC 103 provides notification of the termination to the distribution server 101.

According to the process in FIG. 5, if a destination printer is a virtual printer (YES in step S503), the distribution of the content to the destination printer is inhibited. Therefore, it is possible to distribute or print, for example, digital content data having its own copyright or right of portrait or digital content that is a potential marketable security, without fear of unauthorized copying by a malicious user.

FIG. 6 shows a flowchart illustrating an exemplary procedure for a printer driver check process executed in step S502 shown in FIG. 5. This process is to determine whether the printer selected in step S501 is a virtual printer. Normally, when a printer driver is installed, parameters peculiar to vendors or those to printer models are stored in the system. For example, in the case of Windows (registered trademark), they are stored in the registry. Regarding the virtual printer, peculiar parameters are also stored in the system, similarly to the printer driver.

Referring to FIG. 6, first an NG word is extracted from a database (DB), which has been previously registered in the system, and then stored in an internal, storage area of the PC 103 (step S601). The NG word is a set of parameters, stored when the virtual printer is installed, for specifying a virtual printer frequently used in general under the management of the database. Subsequently, the parameters of the printer driver of the printer selected in step S501 is compared with the NG word extracted in step S601. Unless they coincide with each other as a result of the comparison, the printer selected in step S501 is determined not to be a virtual printer (step S602) and then this process is terminated. On the contrary, if they coincide with each other as a result of the comparison, the selected printer is determined to be a virtual printer.

FIG. 7 shows a flowchart illustrating an exemplary procedure for a printer driver setting process executed in the step S504 shown in FIG. 5.

Referring to FIG. 7, a printer driver setting screen is displayed first, and then a user inputs basic settings such as the paper type, paper size, print quality and so forth (step S701) to obtain the state of the printer driver for which the user has made the settings (step S702). Subsequently, the obtained setting state is stored (step S703).

Even if the number of copies to be printed is set to two or more in step S701, the number of copies is forcibly set to one (step S704). In view of increasing the print efficiency, a driver is usually set to the state of “spooling a print document once and then sending print data to the printer.” If, however, the user further inputs the setting of “leaving the document after printing” in the spool setting, raw data can be stored after the printing. The content can be output many times by using the stored raw data. Therefore, the setting of “sending data directly to the printer” is forcibly made in the spool setting to make it impossible for the raw data to be stored (step S705) and then this process is terminated.

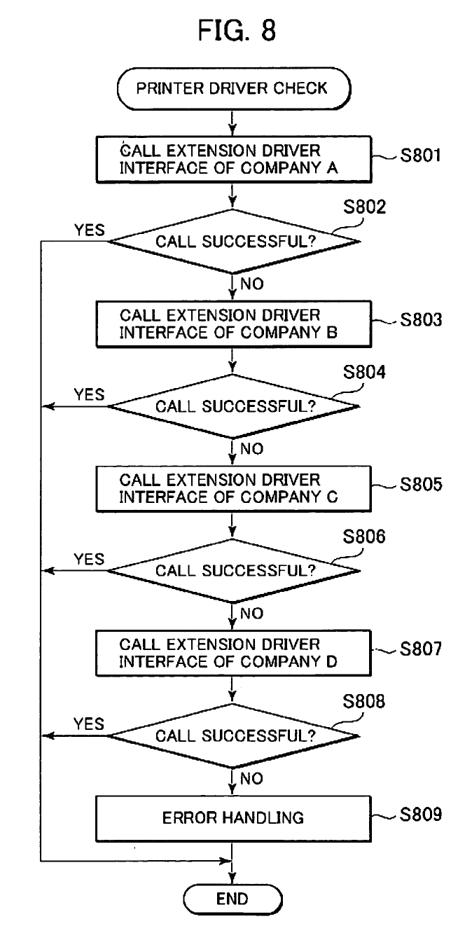

FIG. 8 shows a flowchart illustrating an exemplary procedure for an alteration of the printer driver check process shown in FIG. 6.

In the first embodiment, the printer driver has been checked by extracting the NG word from the database as a measure against virtual printers. In this embodiment, however, the printer driver is checked by using an extension driver interface or the like, which is released from a printer vendor.

The extension driver interface is an interface that is released with unique specifications from each printer vendor. Moreover, the extension driver interface is for use in internally setting the unique paper type, paper size, and so forth prepared by the printer vendor, instead of setting them on the user interface (UI). Generally, the extension driver interface is used by calling a function for the printer driver.

In this process, it is assumed as a precondition that the content distribution and printing system supports printers manufactured by Company A, Company B, Company C, and Company D and therefore is compatible with the extension driver interfaces of the printer vendors of the Company A to Company D.

Referring to FIG. 8, the extension driver interface of Company A is called for the printer driver of the selected printer (step S801) and then it is determined whether the call is successful (step S802). If the call is successful, the check is completed and therefore this process is terminated. If unsuccessful, the extension driver interface of Company B is called (step S803) and then it is determined whether the call is successful (step S804). If the call is successful, the check is completed and therefore this process is terminated. If unsuccessful, the extension driver interface of Company C is called (step S805) and then it is determined whether the call is successful (step S806). If the call is successful, the check is completed and therefore this process is terminated. If unsuccessful, the extension driver interface of Company D is called (step S807) and then it is determined whether the call is successful (step S808). If the call is successful, the check is completed and therefore this process is terminated. If unsuccessful, error handling is performed (step S809) and then this process is terminated. If the call is successful, the selected printer is determined not to be a virtual printer. If the call is unsuccessful, the selected printer is determined to be a virtual printer.

Moreover, the present invention can also be achieved by supplying a system or an apparatus with a storage medium (or a recording medium) storing a program code of software for performing the functions of the above embodiments, whereby the computer (or the CPU or MPU) of the system or apparatus reads and executes the program code stored in the storage medium. In this instance, the program code read from the storage medium performs the functions of the above embodiments and therefore the storage medium storing the program code embodies the present invention.

Additionally, the present invention is not limited to the above embodiments if the functions of the above embodiments are performed by executing the program code read by the computer. More specifically, the present invention also includes the case where the operating system (OS) or the like running on the computer performs a part or all of actual processes on the basis of instructions of the program code, whereby the functions of the above embodiments are performed.

Furthermore, the present invention includes the case where the program code read from the storage medium is written into a function expansion card inserted into the computer or a memory provided in a function expansion unit connected to the computer and then the CPU or the like of the function expansion card or the function expansion unit performs a part or all of the actual processes on the basis of instructions of the program code, whereby the functions of the above embodiments are performed.

Still further, as long as the above program can perform the functions of the above embodiments using the computer, it may be provided in the form of an object code, a program executed by an interpreter, or script data or the like supplied to the OS.

The recording medium for providing the program may be, for example, a RAM, a CD-ROM, a DVD, a nonvolatile memory card, other ROMs, or the like, as long as it can store the above program. Alternatively, the above program may be provided by downloading from any other computer, database, or the like, which is not shown, connected to the Internet, a commercial network, a local area network, or the like.

While the present invention has been described hereinabove with reference to the preferred embodiments of the present invention, it is to be understood that the present invention is not limited to the above embodiments but can be modified in various ways within the scope of the claims.

This application claims the benefit of Japanese Patent Laid-Open No.2005-103819, filed Mar. 31, 2005, which is hereby incorporated by reference herein in its entirety.

What is claimed is:

1. A print control apparatus comprising:
a request unit configured to request an output of content data; and
an inhibiting unit configured to inhibit the output of the content data if a destination of the content data is a virtual printer for converting the content data to a file.

2. A print control apparatus according to claim 1, wherein the inhibiting unit resets a mode that allows spooled data to be stored so that the spooled data cannot be stored, unless the destination of the content data is a virtual printer for converting the content data to a file.

3. A print control apparatus according to claim 1, further comprising a downloading unit configured to download the content data from a server.

4. A print control method comprising:
detecting a request for an output of content data; and
inhibiting the output of the content data if a destination of the content data is a virtual printer for converting the content data to a file.

5. The method according to claim 4, wherein the inhibiting includes resetting the mode that allows spooled data to be stored so that the spooled data cannot be stored, unless the destination of the content data is a virtual printer for converting the content data to a file.

6. A print control program comprising:
code configured to detect a request for an output of content data; and
code configured to inhibit the output of the content data if a destination of the content data is a virtual printer for converting the content data to a file.

7. A program according to claim 6, wherein the code configured for includes code configured to reset the mode that allows spooled data to be stored so that the spooled data cannot be stored, unless the destination of the content data is a virtual printer for converting the content data to a file.

8. A print control apparatus comprising:
a request unit configured to request an output of content data; and
an inhibiting unit configured to inhibit the output of the content data if parameters of a printer driver for a destination of the content data include a predetermined keyword.

9. The print control apparatus according to claim 8, wherein the inhibiting unit resets the mode that allows spooled data to be stored so that the spooled data cannot be stored, unless the parameters include the predetermined keyword.

10. A print control method comprising:
detecting a request for an output of content data; and
inhibiting the output of the content data if parameters of a printer driver for a destination of the content data include a predetermined keyword.

11. The method according to claim 10, wherein the inhibiting includes resetting the mode that allows spooled data to be stored so that the spooled data cannot be stored, unless the parameters include the predetermined keyword.

12. A print control program comprising code which perform the steps of:
detecting a request for an output of content data; and
inhibiting the output of the content data if parameters of a printer driver for a destination of the content data include a predetermined keyword.

13. The program according to claim 12, wherein the inhibiting step includes resetting the mode that allows spooled data to be stored so that the spooled data cannot be stored, unless the parameters include the predetermined keyword.
